(19) United States
(12) Patent Application Publication
(10) Pub. No.: US 2006/0166683 A1
(43) Pub. Date: Jul. 27, 2006

(54) Method and system for use of the same time slot of the same channel by multiple pairs of devices via a direct link protocol

(76) Inventors: Sanjeev K. Sharma, Fairfax, VA (US); Jinwoo Hong, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/044,600

(22) Filed: Jan. 26, 2005

(51) Int. Cl. H04Q 7/20

(52) U.S. Cl. 455/456.5; 455/41.2

(57) ABSTRACT

Disclosed are a method and a system for simultaneous direct link communications among a plurality of devices associated with a wireless network. Each associated device has a radio range, within which it can transmit information or data to other associated devices. Each device creates a list of devices that are located within its radio range, called in-range devices. Also, a list of devices that are located outside the radio range, called out-of-range devices, is created for each associated device. Based on the lists of in-range devices and out-of-range devices, the network coordinator, which is one of the wireless devices, determines two or more pairs of devices that can communicate at the same time without radio interference. The network coordinator determines maximum number of pairs in accordance with an algorithm based on a maximum matching problem.

### BACKGROUND OF THE INVENTION

1. Field of the Invention

This invention relates to a data communication system, particularly to a method and system for wireless communication via direct link protocol.

2. Description of the Related Art

Recently, computer network systems have been expanded to use wireless communication systems. Such network systems include a local area network (LAN), a wide area network (WAN), a wireless local area network (WLAN), a wireless personal area network (WPAN), a general packet radio service (GPRS) network and other wireless network systems. The network systems allow communication between various end terminals such as desktop computers, laptop computers, palmtop computers, mobile phones, other portable communication devices and even portable or non-portable electronic devices that traditionally did not have communication capability. Various suggestions and proposals are made to improve throughput of the communication in such network system.

### SUMMARY OF THE INVENTION

One aspect of the invention provides a method for direct link communication among a plurality of devices associated with a wireless network. The method comprises determining two or more pairs of devices among the plurality of associated devices. The two or more pairs of devices are determined such that each device of each pair is an in-range device of the other of the pair, that each device of each pair does not belong to another pair and that each device of each pair is an out-of-range device of each device of another pair. Here, each associated device has a radio range. A device is an in-range device of another if positioned within the radio range of the other. A device is an out-of-range device of another if positioned outside the radio range of the other.

In the above-described method, the wireless network may follow the protocol of IEEE 802.11 standard. The method may further comprise allocating a single time slot to the two or more pairs of devices. The method may further comprise: creating a list of in-range device(s) for each associated device; and wherein the determining is based on the in-range device lists of the devices associated with the network. The in-range device list may be created by each associated device. The creating the in-range device list may comprise identifying sources of packets that are received in the network. The creating the in-range device list may comprise: receiving one or more packets that are being transmitted in the network, each packet comprising a header with a source thereof; reading the header of each packet to obtain information identifying the device that transmitted the packet; and listing the identified device as an in-range device. The creating the in-range device may list comprises: transmitting a request for a response to other associated devices that receives the request; receiving a response transmitted from another associated device; and listing the other device transmitting the response as an in-range device. The method may further comprises sending the in-range device list to a coordinator of the network.

The above-described method may further comprise: creating a list of out-of-range device(s) for each associated device; and wherein the determining is based on the out-of-range device lists of the devices associated with the network. The creating the out-of-range device list for each associated device may be based on an in-range device list thereof and a list of all of the devices associated with the network. The creating the out-of-range device list for each associated device may comprise excluding in-range device(s) of each associated device from the list of all of the devices associated with the network. The out-of-range device list may be created by each associated device, and wherein the list of all of the associated devices may be supplied to each associated device by a coordinator of the network. The out-of-range device list may be created for each associated device by a coordinator of the network, and wherein the in-range device list is supplied to the coordinator by each associated device. A maximum number of device pairs may be determined in accordance with an algorithm of maximum matching problem. The algorithm may comprise: designating each associated device as a node; connecting nodes of in-range devices in pair; and selecting one or more pairs of nodes, wherein none of the nodes belong to two or more nodes. The algorithm may further comprise, when one node belongs to two or more pairs, selecting only one of the pairs. The selecting one pair may further comprise determining which pair among the two or more pairs needs a priority service.

Another aspect of the invention provides an electronic device capable of wireless communication with other electronic devices. The electronic device has a radio range determined based on transmission power thereof. The electronic device is capable of creating a list of in-range devices that are located within the radio range thereof. The electronic device is capable of creating a list of out-of-range devices that are located outside the radio range thereof. The electronic device may be capable of wireless communicating with other electronic devices in accordance with a protocol of IEEE 802.11 standard.

Another aspect of the invention provides an electronic device capable of coordinate direct link communication among a plurality of devices associated with a wireless network. Each device associated with the network has a radio range thereof. The electronic device comprises a processor configured to determine two or more pairs of devices among the plurality of associated devices; and a wireless transmitter connected to the processor and configured to transmit information of the two or more pairs of determined devices. Here, each device of each pair is positioned within the radio range of the other device of the pair, each device of each pair does not belong to another pair, and each device of the each pair is positioned outside the radio range of each device of another pair.

In the above-described electronic device, the processor may be further configured to allocate a single time slot to the two or more pairs of devices. The wireless transmitter may be further configured to transmit information of the allocated single time slot along with the information of the two or more pairs of determined devices. The electronic device may be configured to coordinate direct link communication among the plurality of devices in accordance with a protocol of IEEE 802.11 standard.

Still another aspect of the invention provides a wireless electronic device capable of being a network coordinator. The device comprises: means for determining two or more pairs of devices among a plurality of devices; and means for allocating a single time slot to the two or more pairs of devices for simultaneous communication. Here, devices of the two or more pairs are positioned such that each pair can communicate via a direct link protocol substantially free of radio interference with communication of another pair. The wireless electronic device may be configured to communicate in accordance with a protocol of IEEE 802.11 standard.

A further aspect of the invention provides a wireless communication system for simultaneous direct link communication. The system comprises: a plurality of devices associated with a wireless network, a coordinator of the network configured to broadcast information of two or more pairs of devices for simultaneous direct link communications in a single channel. The two or more pairs of devices are configured to communicate in accordance with the information broadcast by the coordinator. The coordinator is configured to determine the two or more pairs of associated devices based on relative position of each associated device. In the system, the direct link communication may be performed in accordance with a protocol of IEEE 802.11 standard.

### BRIEF DESCRIPTION OF THE DRAWINGS

FIG. 1 is a schematic illustration of a wireless network where the invention can be implemented.

FIG. 2 is the wireless network of FIG. 1, further illustrating wireless communication among devices.

FIG. 3 is a flowchart of an embodiment of the invention for allocating a single time slot to multiple pairs of devices for simultaneous communications in the network of FIGS. 1 and 2.

FIG. 4A is a flowchart of an embodiment of the invention for creating a list of in-range device(s) for each device associated with the network of FIGS. 1 and 2.

FIG. 4B is lists of in-range device(s) for the associated devices created based on the network state illustrated in FIG. 2.

FIG. 5A is a flowchart of an embodiment of the invention for creating a list of out-of-range device(s) for each device associated with the network of FIGS. 1 and 2.

FIG. 5B is lists of of-range device(s) for the associated devices created based on the network state illustrated in FIG. 2.

FIG. 6 is a flowchart of another embodiment of the invention for creating a list of out-of range device(s) for each device associated with the network of FIGS. 1 and 2.

FIG. 7 is a flowchart of an embodiment of the invention for determining maximum number of pairs of devices that can simultaneously communicate in a single channel without causing radio interference with each other.

FIG. 8 is a graphical illustration of the process of the embodiment of FIG. 7 for determining maximum number of pairs of devices that can simultaneously communicate in a single channel.

FIG. 9 is the network of FIG. 2 with the implementation of an embodiment of the invention, illustrating simultaneous communication between two pairs of devices without radio interference with each other.

FIG. 10 is a part of a beacon frame broadcasted in the network, illustrating that the same channel time allocation (CTA) is allocated to multiple pairs of devices.

### DETAILED DESCRIPTION OF THE PREFERRED EMBODIMENT

The features of the invention will become more fully apparent from the following description and appended claims taken in conjunction with the foregoing drawings. In the drawings, like reference numerals indicate identical or functionally similar elements.

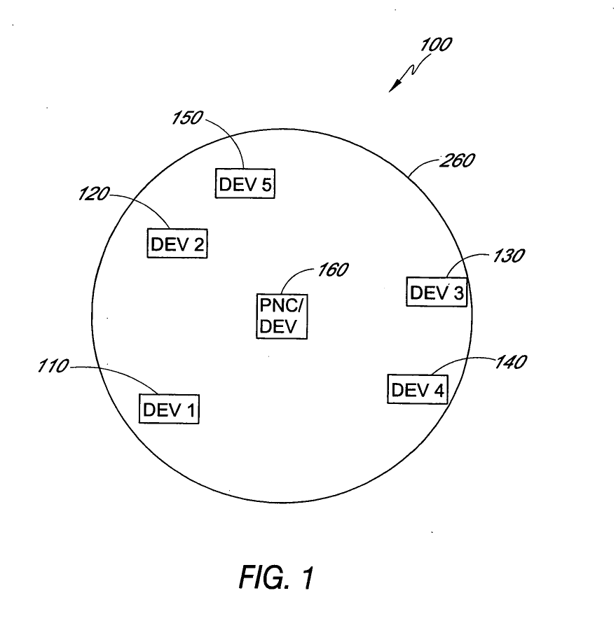

FIG. 1 illustrates an exemplary wireless network system 100 including various wireless devices (DEV) 110-160 communicating with one another. In one embodiment, the network system 100 constitutes a “wireless personal area network (WPAN)” or “piconet.” In other embodiments, the network system 100 may be any other types of wireless network systems that allow direct link communication between wireless devices. The term “direct link” refers to a data communication link formed directly between two devices, not via another device such as a network coordinator or controller. In one embodiment, the wireless network system 100 follows the protocol of the IEEE 802.15.3 standard, which is hereby incorporated herein by reference. In one embodiment, the network system 100 can communicate with other peer network systems (not shown).

Each device 110-160 includes one or more electronic circuits, chips, processors, cards or their equivalents, whether integrally formed or connectable to the device, that are capable of performing processes, methods and/or algorithms that are disclosed herein. The devices 110-160 are any electronic devices capable of wireless communication, including, not limited to, desktop computers, laptop computers, palmtop computers, digital still or video cameras, portable or non-portable video displays, wireless speakers, electronic game devices, printers, scanners, facsimile machines, cordless phones, mobile phones and other business and consumer electronic devices.

The device 160 is a coordinator or controller of the network 100. The coordinator 160 coordinates communication among the devices 110-150 following a direct link protocol. For example, the coordinator 160 allocates a time slot in a channel, a source device for transmitting data and a destination device for receiving the transmitted data from the source device. The allocated information is communicated to the devices 110-150 within the network 100. Then, the source device transmits data and the destination device receives the transmitted data directly from the source device during the allocated time slot.

The circle 260 is an imaginary boundary of the network 100, which represents the radio range of the coordinator 160. The radio range of the coordinator 160 is determined by transmission power of the coordinator 160. The radio range will be further described in more detail. The devices 110-150 are associated with the network 100 via an association process. For example, a non-associated device requests to the coordinator 160 for its association with the network 100, and the coordinator 160 approves association of that device in view of the current conditions of the network 100 and/or the characteristics of the non-associated device. In one embodiment, the association process of the network 100 follows protocols of the IEEE 802.15.3 standard. Through the association processes, the coordinator 160 recognizes all of the devices 110-150 associated with the network 100.

In one embodiment, the coordinator 160 can also function as an associated device for data-communication with other devices 110-150. In one embodiment, one or more of the other devices 110-150 are capable of operating as a coordinator of the network 100. The coordinator may transfer the coordination function to another device having the coordination capability. When another device takes over the coordination of the network 100, the network boundary 260 may change to the boundary of the radio range of the new coordinator. In another embodiment, the coordinator 160 is a dedicated device for the coordination of the network.

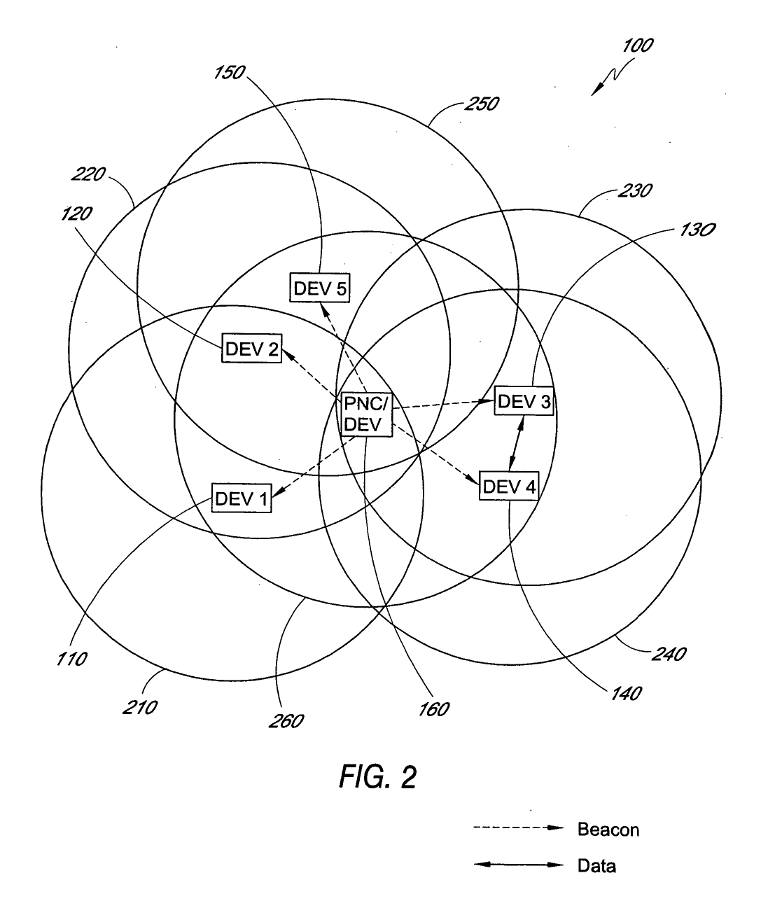

FIG. 2 illustrates a typical communication state in the network 100, for example, based on IEEE 802.15.3 standard. The dotted arrows refer to beacon frames, which are signals broadcasted by the coordinator 160 to the associated devices 110-150. The beacon frames include, among others, information of time slots and pairs of the devices that can communicate with each other within the allocated time slots. The coordinator 160 allocates each time slot to only one pair of devices (source and destination devices) and ensures that no other devices will attempt to transmit data during the time allocated for the pair. This is to avoid any radio interference that can happen if two or more devices transmit data at the same time. In FIG. 2, for example, only the devices 130 and 140 are data-communicating with each other, while all of the other devices 110, 120 and 150 are not.

If more than one pair of devices can communicate during a single time slot, throughput efficiency of the network 100 can be improved. Simultaneous communications of more than one pair of devices may be possible by utilizing multiple frequency channels as in a frequency division multiple access (FDMA) system. However, if the network is set up for a single frequency channel communication, multiple channel communication may not be possible.

The invention enables simultaneous communication of multiple pairs of devices even in a single channel system or in each channel of a multiple channel system. The invention provides selection multiple pairs of devices that are available for simultaneous communication without causing radio interference. Further, the invention provides selection of maximum number of pairs that can communicate at the same time without causing radio interference. Now the concept and embodiments of the invention are described in detail.

The circles 210-260 of FIG. 2 are imaginary boundaries of the radio ranges of the associated devices 110-160, respectively. Each device's radio transmission carries an amount of power that can be received by a receiving device up to the boundary of its radio range. A minimum amount of power that can be received by another device will be well appreciated by one of ordinary skill in the art. As such, information or data transmitted from a transmitting device can only be received by devices positioned within the radio range of the transmitting device. If a device is located outside the radio range of the transmitting device, that device may not receive the data transmitted by the transmitting device. For the sake of simplicity, the circles 210-260 of FIG. 2 are drawn in about the same size. In actual embodiment, however, the radio range of each device may vary. In another embodiment, the radio ranges of the associated devices are substantially same with one another.

Any two devices, which are positioned outside the radio range of the other, cannot receive data transmitted from the other. In the state of the network 100 illustrated in FIG. 2, such pairs are the pair of devices 110 and 130, the pair of devices 110 and 140, the pair of devices 120 and 130, the pair of devices 120 and 140, the pair of devices 150 and 130, the pair of devices 150 and 150, and the pair of devices 110 and 150. And, transmission by either device 130 or device 140 would not be received by any of the devices 110, 120 and 150. Similarly, transmission by any of the devices 110, 120 and 150 would not be received by the device 130 or 140.

On the other hand, any pair of devices, each of which is positioned within the radio range of the other, can transmit and receive data between them. In the state of the network 100 illustrated in FIG. 2, such pairs are the pair of devices 110 and 120 (P1), the pair of devices 130 and 140 (P2), and the pair of devices 120 and 150 (P3). As noted above, the transmission by either of the devices 130 and 140 cannot be heard by the pair of devices 110 and 120 (P1), or the pair of devices 120 and 150 (P3), vice versa. Thus, the pair of devices 130 and 140 (P2) can communicate with each other simultaneously with one of the pair of devices 110 and 120 (P1) and the pair of devices 120 and 150 (P3) without causing radio interference.

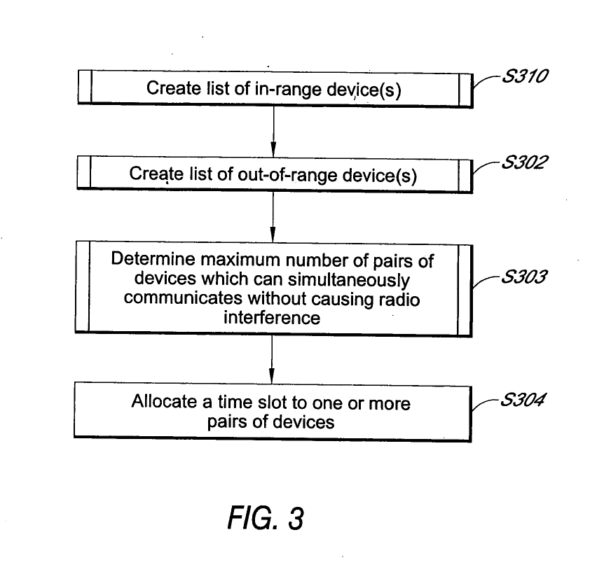

FIG. 3 illustrates one embodiment of the invention for determining multiple pairs of devices that can communicate without causing wireless interference. For each associated device, a list of its in-range device(s) is created (step S301). Also, for each associated device, a list of its out-of-range device(s) is created (step S302). The step S302 for creating the out-of-range devices can be conducted before the step S301 for creating the in-range devices. After creating the lists of in-range devices and out-of-range devices, the coordinator 160 or an appropriate device of the network 100 determines one or more pairs of devices that can simultaneously communicate without causing radio interference (step S303). Optionally, the maximum number of pairs that can simultaneously communicate is determined. Once one or more pairs of devices are determined, the coordinator 160 allocates a single time slot to the one or more pairs. One of ordinary skill in the art will be able to implement this embodiment in the form of software and/or hardware of wireless devices.

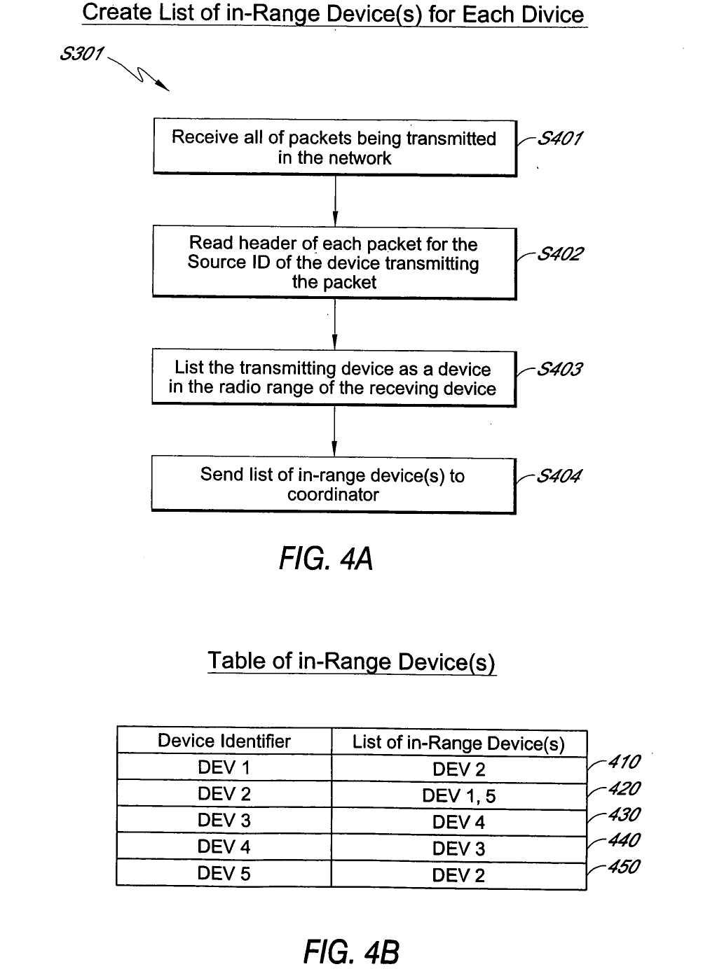

FIG. 4A illustrates an embodiment of the invention for creating a list of in-range devices for each associated device (step S301). To create the list of in-range devices, each device receives to all the packets transmitted in the network 100 (step S401). Upon receiving each packet, the receiving device can find out the source identifier (SrcID) of the device transmitting the packet by reading the header of the received packet (step S402). Then, the receiving device creates a list of the transmitting devices, which is essentially the list of in-range devices (step S403). The created list or corresponding information is sent to the coordinator 160 (step S404). One of ordinary skill in the art will be able to implement this embodiment in the form of software and/or hardware of wireless devices.

As a definition, “in-range devices” of a (receiving) device are the associated devices that are positioned within the radio range of the (receiving) device. However, in this embodiment, the list of in-range devices is a list of the transmitting devices that transmitted a packet that was received by the receiving device. This list of the transmitting devices may be different from the actual list of the “in-range devices.” However, in an embodiment where the radio ranges of the associated devices are substantially the same (a symmetric link), the list of the transmitting devices is the same or substantially the same as the actual list of in-range devices of the receiving device.

In another embodiment, the receiving device may transmit a request (for example, probe request to be discussed below) to other devices prior to the step S401, and read the received packets that only reply to the request in step S402. In this embodiment, the list of the devices transmitting the packets replying to the request will more accurately reflect the in-range devices because only those within the radio range of the receiving device will reply to the request. One of ordinary skill in the art will be able to implement this embodiment in the form of software and/or hardware of wireless devices.

Each associated device creates its own in-range device list and sends the list to the coordinator 160. Each device may save the created list in a memory before sending to the coordinator 160. The coordinator 160 receiving a list from each device may save the list in a memory. FIG. 4B shows collective lists 410-450 of in-range devices for the associated device 110-150 created based on the network state illustrated in FIG. 2.

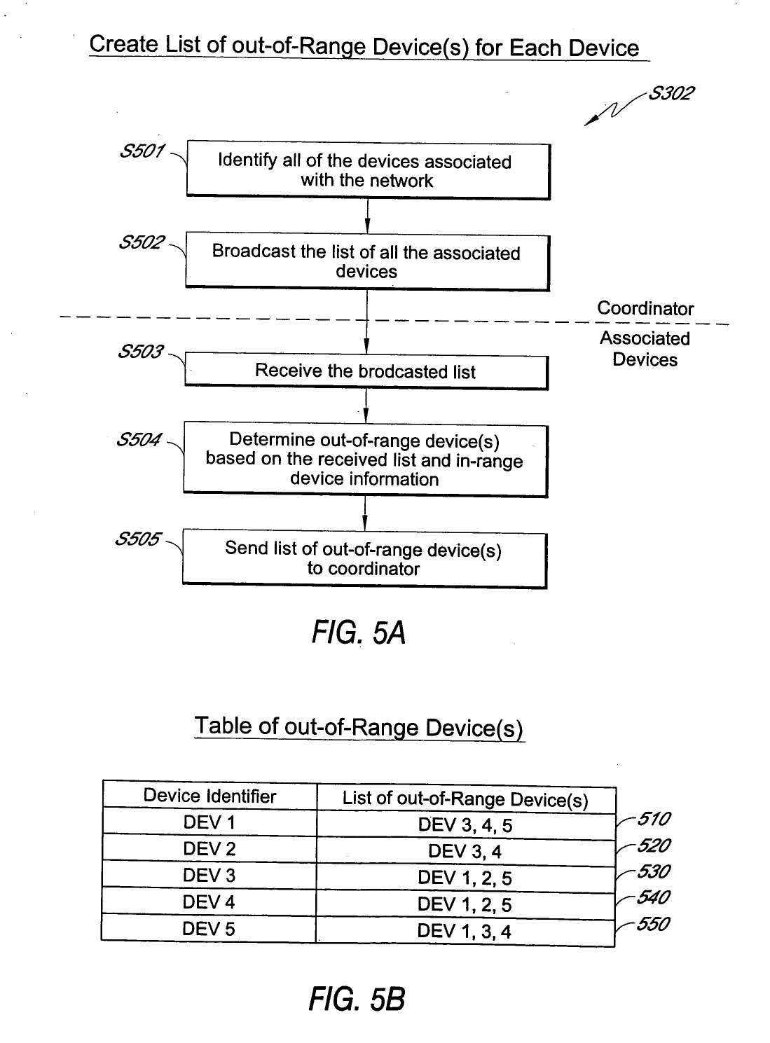

FIG. 5A illustrates an embodiment of the invention for creating the list of out-of-range devices for each associated device. The out-of-range devices are identified by each associated device with the assistance of the coordinator 160. First, the coordinator 160 identifies all of the associated devices 110-150 (step S501). In one embodiment, this step S501 is accomplished by the association process, as described above. The coordinator 160 knowing all of the devices 110-150 associated with the network 100, periodically broadcast the list of all the associated devices and their identifiers as part of beacon frames (step S502). All of the devices in the network 100 will receive this information (step S503). Now each device knows all the other devices 110-150 present in the network. Using the list of all the associated devices 110-150 and the list of in-range devices 410-450 created in the step S301, each associated device can determine the out-of-range devices (step S504). Then, the list or information of out-of-range devices is sent to the coordinator 160 (step S505). One of ordinary skill in the art will be able to implement this embodiment in the form of software and/or hardware of wireless devices.

As illustrated, the steps S503-505 of FIG. 5A are conducted in each of the associated devices 110-150. The created list may be saved in a memory before sending to the coordinator 160. The coordinator 160 receiving the list of out-of-range devices from each associated device may save the list in a memory. FIG. 5B shows collective lists 510-550 of out-of-range devices for the associated device 110-150 created based on the network state illustrated in FIG. 2. The lists 510-550 of out-of-range devices of each device can be created by simply excluding the in-range devices and the own device from the list of all the associated devices 110-150. One of ordinary skill in the art will be able to implement this embodiment in the form of software and/or hardware of wireless devices.

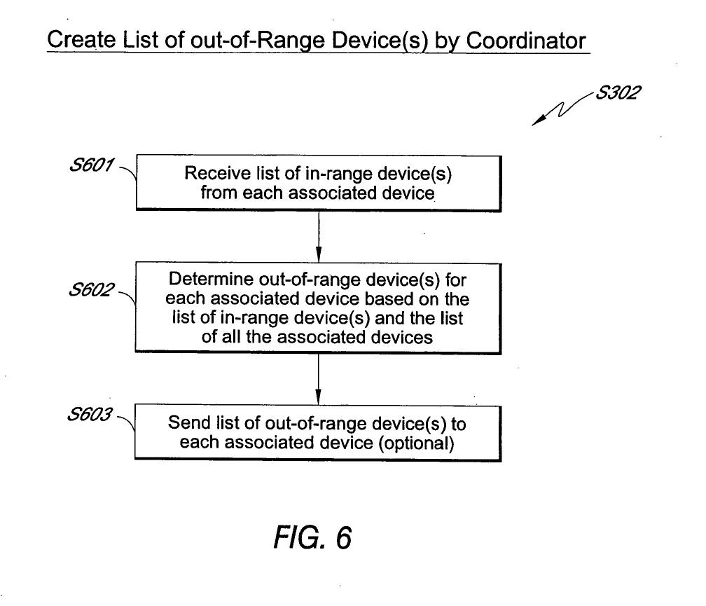

In another embodiment, a list of out-of-range devices may be created by the coordinator 160. Referring to FIG. 6, the coordinator 160 receives the list or information of in-range devices from each associated device (step S601). The coordinator 160 then determines out-of-range devices for each associated device based on the list of in-range devices and the list of all the associated devices (step S602) in the same way as each associated device does the determination in step S504. Optionally, the coordinator 160 sends the list of out-of-range devices of each associated device to that device (step S603). One of ordinary skill in the art will be able to implement this embodiment in the form of software and/or hardware of wireless devices.

There can be some situations whose relative position (in-range or out-of range) of an associated device is not known. This can happen, for example, when an associated device becomes inactive and does not receive or transmit any data. Since this device of unknown status is included in the list of all associated devices, the other associated devices recognize the existence of the device of unknown status. Then, each device can transmit a probe request to find out whether the peer device of unknown status is in-range or out-of range. The probe request is a request for a response thereto sent by an associated device to the peer devices that are part of the association list broadcasted by the coordinator but were not determined either in-range or out-of-range devices. If the device of unknown status now responds to the probe request, then that device will be considered in range. If no response is received from the device of unknown status, then that device can be considered as out-of-range. The foregoing process helps each device determine the in-range and out-of-range devices more accurately. To avoid any collisions of multiple probe requests that can be transmitted at once by multiple devices, techniques such as slotted aloha or carrier sense multiple access with collision avoidance (CSMA/CA) may be used.

Referring back to FIG. 3, after creating lists of in-range and out-of-range devices, one or more pairs of devices that can simultaneously communicate are determined (step S303). This determination is conducted by the coordinator 160 of the network 100 based on the information of the in-range and out-of-range devices for each device. In one embodiment, the determination of pairs can be made by an algorithm based on maximum matching problem (based on graph).

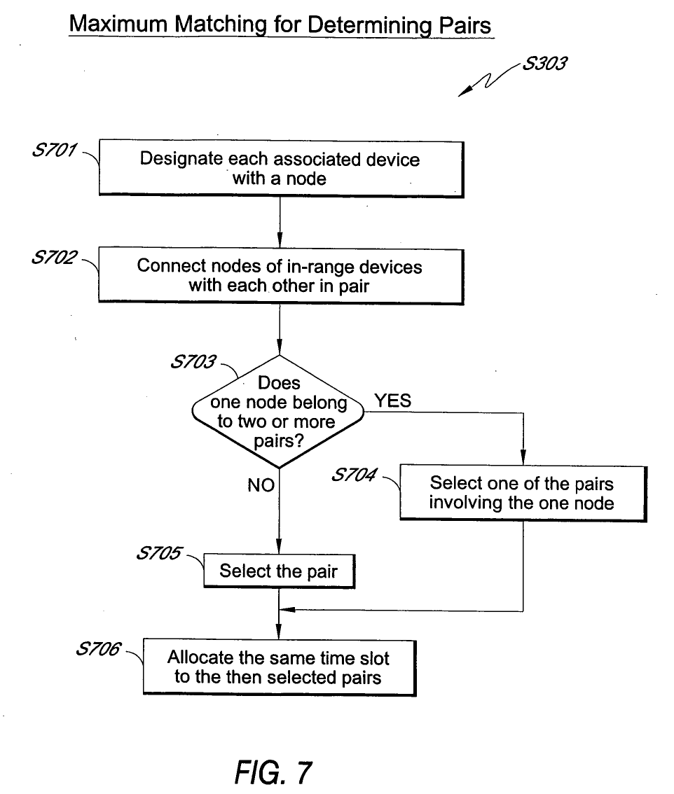

FIG. 7 illustrates an embodiment of determining pairs of devices based on the maximum matching problem. First, all of the associated devices 110-160 including the coordinator are designated by nodes 110-160 (step S701). Then, the nodes of in-range devices are connected to each other in pair (step S702). Next, whether one node belongs to two or more pairs is determined (step S703). If one node belongs to two or more pairs (Yes in S703), the coordinator 160 selects only one of the pairs (step S704). In one embodiment, the pair that needs services before the other pairs is selected. If each node of a pair belong to only that pair (No pair in S703), the coordinator selects that pair (step S705). Now, the coordinator 160 allocates the same time slot to then selected pairs (step S706). One of ordinary skill in the art will be able to implement this embodiment in the form of software and/or hardware of wireless devices.

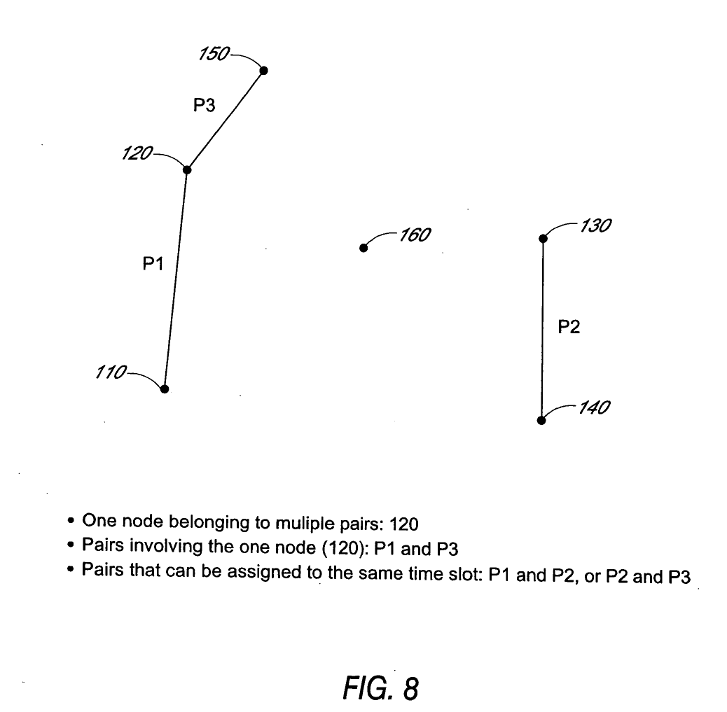

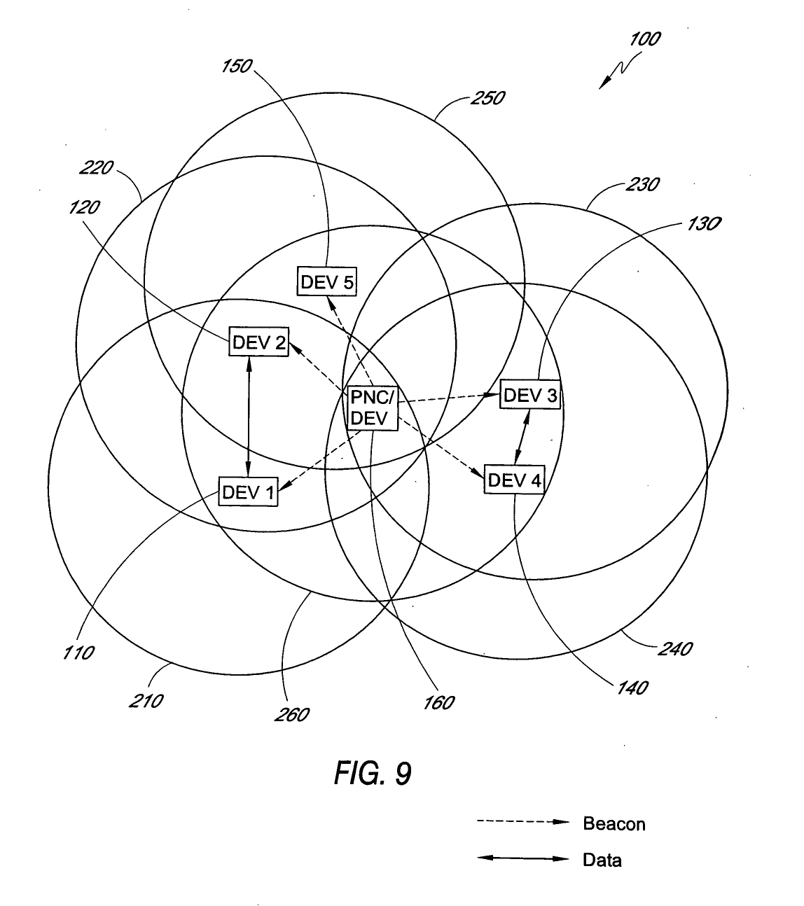

FIG. 8 graphically illustrates the process of FIG. 7. Each device is represented by a node 110-160 based on the network 100 of FIG. 2 (step S701). The in-range device pairs P1 (devices 110 and 120), P2 (devices 130 and 140) and P3 (devices 120 and 150) based on the table of FIG. 4B are connected by lines (step S702). It is determined that the node 120 belongs to two pairs P1 and P3 (step S703). Then, the pair P1 is selected and the pair P3 crossed out (step S704). It is determined that each of the nodes 130 and 140 belongs to only one pair P2 (step S703), and the pair P2 is selected (step S705). As a result, the pairs P1 and P2 are selected for the same time slot. FIG. 9 illustrates the simultaneous communication between the devices 110 and 120 of pair P1 and between the devices 130 and 140 of pair P2 without causing radio interference.

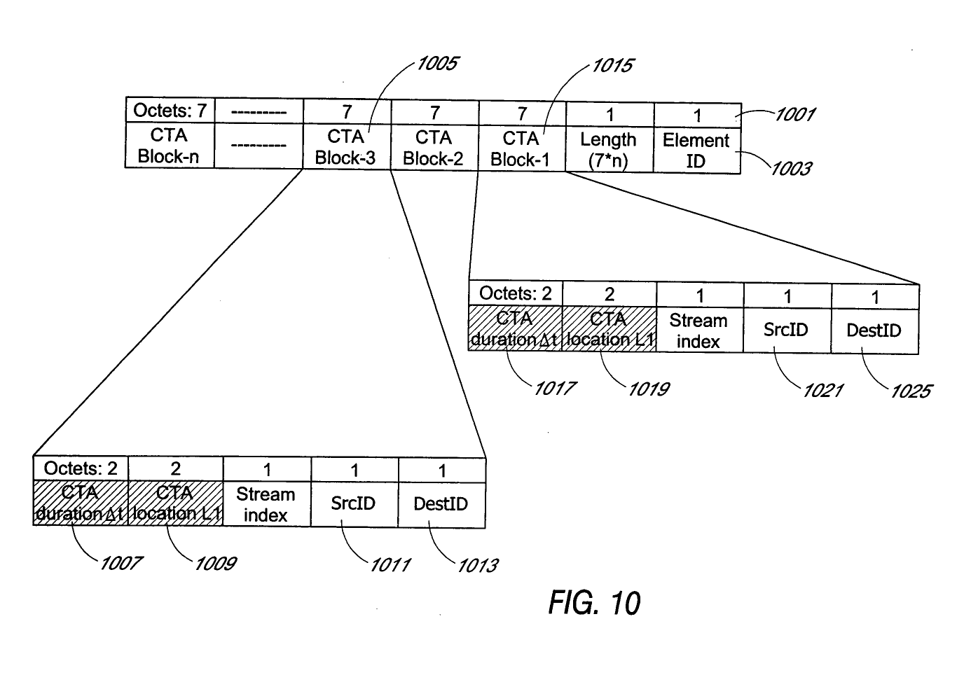

FIG. 10 illustrates exemplary channel time allocation (CTA) information that is broadcasted as part of beacon frames by the coordinator 160 to the associated devices 110-150. Each block of the first row 1001 provides the size (in octets) of the information contained in the block immediately below it. The blocks of second row 1003 contain information that the coordinator 160 broadcasts to the associated devices 110-150 of the network 100. One of ordinary skill in the art will readily appreciate this and other structures of the beacon frames.

In the illustrated example, the block 1005 (CTA Block-3) and block 1015 (CTA Block-1) contain 7 octets, which are shown in further detail. The first blocks 1007 and 1017 in 2 octets define CTA duration Δt. The second blocks 1009 and 1019 in 2 octets define CTA location L1, which is the start time of CTA duration Δt. The fourth blocks 1011 and 1021 in 1 octet define the source device of a data transmission (SrcID). The fifth blocks 1013 and 1023 in 1 octet define the destination device of a data transmission (DestID). Here, the coordinator 160 can allocate the identical duration and start time in each of the CTA blocks 1005 and 1015. And, the coordinator 160 designate devices of each pairs for the source and destination devices in each of the CTA blocks 1005 and 1015, for example, the pair P1 for the CTA block 1005 and the pair P2 for the CTA block 1015. The associated devices 110-150 receiving the beacon frame will act according to the CTA information, thereby pair P1 and pair P2 can simultaneously communicate via a direct link between the devices of each pair.

The described invention and embodiments can boosts throughput of wireless personal area network (WPAN) significantly. Throughput efficiency will increase with the increase of the number of independent pairs. The foregoing embodiments are advantageous as they can be simply implemented. Further, it is also advantageous that no changes are needed to the IEEE 802.15.3 standard in implementing the embodiments.

It is to be understood that one of ordinary skill in the appropriate arts may modify the invention here described while still achieving the favorable results of this invention. Accordingly, the description is to be understood as being a broad, teaching disclosure directed to persons of skill in the appropriate arts, and not as limiting upon the invention.

What is claimed is:

1. A method for direct link communication among a plurality of devices associated with a wireless network, the method comprising:
determining two or more pairs of devices among the plurality of associated devices, each associated device having a radio range;
wherein each device of each pair is an in-range device of the other of the pair, each device being an in-range device of another if positioned within the radio range of the other;
wherein each device of each pair does not belong to another pair; and
wherein each device of each pair is an out-of-range device of each device of another pair, each device being an out-of-range device of another if positioned outside the radio range of the other.

2. The method of claim 1, wherein the wireless network follows the protocol of IEEE 802.11 standard.

3. The method of claim 1, further comprising allocating a single time slot to the two or more pairs of devices.

4. The method of claim 1, further comprising:
creating a list of in-range device(s) for each associated device; and
wherein the determining is based on the in-range device lists of the devices associated with the network.

5. The method of claim 4, wherein the in-range device list is created by each associated device.

6. The method of claim 4, wherein the creating the in-range device list comprises identifying sources of packets that are received in the network.

7. The method of claim 4, wherein the creating the in-range device list comprises:
receiving one or more packets that are being transmitted in the network, each packet comprising a header with a source thereof;
reading the header of each packet to obtain information identifying the device that transmitted the packet; and
listing the identified device as an in-range device.

8. The method of claim 4, wherein the creating the in-range device list comprises:
transmitting a request for a response to other associated devices that receives the request;
receiving a response transmitted from another associated device; and
listing the other device transmitting the response as an in-range device.

9. The method of claim 4, further comprising sending the in-range device list to a coordinator of the network.

10. The method of claim 1, further comprising:
creating a list of out-of-range device(s) for each associated device; and
wherein the determining is based on the out-of-range device lists of the devices associated with the network.

11. The method of claim 10, wherein the creating the out-of-range device list for each associated device is based on an in-range device list thereof and a list of all of the devices associated with the network.

12. The method of claim 11, the creating the out-of-range device list for each associated device comprises excluding in-range device(s) of each associated device from the list of all of the devices associated with the network.

13. The method of claim 11, wherein the out-of-range device list is created by each associated device, and wherein the list of all of the associated devices is supplied to each associated device by a coordinator of the network.

14. The method of claim 11, wherein the out-of-range device list is created for each associated device by a coordinator of the network, and wherein the in-range device list is supplied to the coordinator by each associated device.

15. The method of claim 1, wherein a maximum number of device pairs is determined in accordance with an algorithm of maximum matching problem.

16. The method of claim 15, wherein the algorithm comprises:
designating each associated device as a node;
connecting nodes of in-range devices in pair; and
selecting one or more pairs of nodes, wherein none of the nodes belong to two or more nodes.

17. The method of claim 16, wherein the algorithm further comprises, when one node belongs to two or more pairs, selecting only one of the pairs.

18. The method of claim 17, wherein selecting one pair further comprises determining which pair among the two or more pairs needs a priority service.

19. An electronic device capable of wireless communication with other electronic devices, wherein the electronic device has a radio range determined based on transmission power thereof, wherein the electronic device is capable of creating a list of in-range devices that are located within the radio range thereof, and wherein the electronic device is capable of creating a list of out-of-range devices that are located outside the radio range thereof.

20. The electronic device of claim 19, wherein the electronic device is capable of wireless communicating with other electronic devices in accordance with a protocol of IEEE 802.11 standard.

21. An electronic device capable of coordinate direct link communication among a plurality of devices associated with a wireless network, each device having a radio range thereof, the electronic device comprising:
a processor configured to determine two or more pairs of devices among the plurality of associated devices, wherein each device of each pair is positioned within the radio range of the other device of the pair, wherein each device of each pair does not belong to another pair, and wherein each device of the each pair is positioned outside the radio range of each device of another pair; and
a wireless transmitter connected to the processor and configured to transmit information of the two or more pairs of determined devices.

22. The electronic device of claim 21, wherein the processor is further configured to allocate a single time slot to the two or more pairs of devices, and wherein the wireless transmitter is further configured to transmit information of the allocated single time slot along with the information of the two or more pairs of determined devices.

23. The electronic device of claim 21, wherein the device is configured to coordinate direct link communication among the plurality of devices in accordance with a protocol of IEEE 802.11 standard.

24. A wireless electronic device capable of being a network coordinator, the device comprising:
means for determining two or more pairs of devices among a plurality of devices, wherein devices of the two or more pairs are positioned such that each pair can communicate via a direct link protocol substantially free of radio interference with communication of another pair; and
means for allocating a single time slot to the two or more pairs of devices for simultaneous communication.

25. The wireless electronic device of claim 24, wherein the device is configured to communicate in accordance with a protocol of IEEE 802.11 standard.

26. A wireless communication system for simultaneous direct link communication, the system comprising:
a plurality of devices associated with a wireless network;
a coordinator of the network configured to broadcast information of two or more pairs of devices for simultaneous direct link communications in a single channel;
wherein the two or more pairs of devices are configured to communicate in accordance with the information broadcasted by the coordinator; and
wherein the coordinator is configured to determine the two or more pairs of associated devices based on relative position of each associated device.

27. The system of claim 26, wherein the direct link communication is performed in accordance with a protocol of IEEE 802.11 standard.
